(19) United States
(12) Patent Application Publication
(10) Pub. No.: US 2020/0196517 A1
(43) Pub. Date: Jun. 25, 2020

(54) PRODUCTION LINE FOR AFFORESTATION

(71) Applicant: Zhengyong SU, Shandong (CN)

(72) Inventor: Zhengyong SU, Shandong (CN)

(21) Appl. No.: 16/808,386

(22) Filed: Mar. 4, 2020

Related U.S. Application Data
(63) Continuation of application No. PCT/CN2018/093647, filed on Jun. 29, 2018.

(51) Int. Cl. A01C 5/04; A01G 23/04; B60P 3/32; E04B 1/343

(52) U.S. Cl. CPC A01C 5/04; A01G 23/04; A01G 25/09; E04B 1/34336; B60P 3/32

(57) ABSTRACT

The present application discloses a production line for afforestation. The technical solution includes at least one mobile platform which has a living area formed thereon, a column disposed at the bottom thereof for forming a sunshade area under the mobile platform for cultivating seedlings, and a walking mechanism installed at the bottom of the column. The production line is convenient for the people to plant trees in the desert.

### CROSS-REFERENCE TO RELATED APPLICATION

This application is a continuation of international PCT application serial no. PCT/CN2018/093647, filed on Jun. 29, 2018. The entirety of the above-mentioned patent application is hereby incorporated by reference herein and made a part of this specification.

### FIELD OF THE INVENTION

The invention relates to the field of planting trees in deserts, and in particular to a production line for afforestation.

### DESCRIPTION OF RELATED ART

With the continuous degrading of the climate on the earth, more and more lands tend to become desertificated, which invades and harasses the life of the human being, but the resistance from the people against the invasion of the deserts is usually small and powerless. The people who want to plant trees for afforestation have to trudge over a long distance every time, but have little time spent on work, since most of the time have to be wasted on the trudge.

In the prior art, the closest technique is a touring car traveling on the road, which can be driven to move forward or backward or make a turn, and provide an accommodation for a person to conveniently live in. A large caravan has a two-layer structure, and is generally driven by fuel combustion. The caravan is mainly used for serving the people by travelling and parking on the road and providing convenient eating, residing and traveling for them, but has the disadvantage of inconvenience for working in a desert.

### BRIEF SUMMARY OF THE INVENTION

An object of the present application is to provide a production line for afforestation, which provides the people with the advantage of convenient operation in the desert.

The above object of the present application is achieved by the following technical solution: a production line for afforestation, comprising at least one mobile platform which has a living area formed thereon, a column disposed at the bottom thereof for forming a sunshade area under the mobile platform for cultivating seedlings, and a walking mechanism installed at the bottom of the column.

By adopting the above technical solution, when planting trees in the desert, a person can live in the living area, including eating and residing in the living area, so that he can work in the desert for a long time. At the same time, the mobile platform can shelter newly planted seedlings against the sunlight, making the seedlings more likely to survive through the early stage in the desert.

Preferably, there are at least three mobile platforms arranged in front and back order and advancing at the same speed, with a gap formed between adjacent mobile platforms for sunlight penetration.

By adopting the above technical solution, the sunshade area is increased. The mobile platforms can be kept in a moving state to block the sunlight alternately. After 3 to 7 days, the seedlings can independently live outside the sunshade area, so that they can also be irradiated by the sunlight for a certain period of time, rather than being exposed to the harsh sunlight for a long time. Moreover, the platform is always kept in a moving state and does not need to be restarted after stopping, which saves energy source.

Preferably, the mobile platform comprises a mobile village comprising a base platform having a grid structure in which a house is fixedly connected.

By adopting the above technical solution, the house can provide the workers with better life, and even the life with their families in the desert. Preferably, a plurality of families can form a living area so as to greatly extend the working time in the desert. The overall structure of the grid structure is relatively stable while being relatively light in weight.

Preferably, a ceiling is installed at the top of the base platform, comprising a plurality of solar panels which are assembled into the ceiling.

By adopting the above technical solution, since the sun in the desert is fiercer and the solar energy is more abundant during the daytime, the solar panels can obtain richer energy, which is environmentally friendly while being conducive to a long-term operation.

Preferably, the ceiling comprises a plurality of solar rainwater collectors, the solar rainwater collectors comprise an upper cone part protruding upward and a collection groove formed around the upper cone part by downward depression, the edge of the upper cone part and the edge of the collection groove are joined with each other, and the bottom of the collection groove is provided with a water outlet.

By adopting the above technical solution, the collection groove can collect some rainwater which can be stored and conveniently used later. This is environmentally friendly while being conducive to a long-term life in the desert.

Preferably, the mobile platform comprises a caravan, and the caravan comprises the base platform and a functional field provided on top of the base platform.

By adopting the above technical solution, the mobile platform is convenient for the persons to live. It can also be used as a place of entertainment for adjusting the life of the persons, or as a place for a helicopter to land on, facilitating supplies transportation and personnel rescue, so that the persons can live in the desert for a better and longer time.

Preferably, the mobile platform further comprises a sunshade which comprises a ceiling and the base platform located under the ceiling, with a culturing area formed between the ceiling and the base platform or within the base platform.

By adopting the above technical solution, the source of meat for surviving in the desert can be partly guaranteed, so that quality of life and long-term survival can be ensured.

Preferably, a lifting channel is formed on the mobile platform, in which one end of the column is slidably connected, and a lifting device is arranged between the column and the lifting channel for driving one of them to move relative to the other.

By adopting the above technical solution, the lifting device can drive the lifting of the base platform and facilitate the operation of large machinery in the sunshade area.

Preferably, the lifting device comprises a gear, a lifting motor driving the gear to rotate, and a rack fixed on the inner side of the lifting channel and meshed with the gear.

By adopting the above technical solution, the structure is relatively simple and the drive is relatively stable.

Preferably, the walking mechanism comprises an electric flat car, which comprises a flat car platform, a support arm fixed at the bottom of the flat car platform, a walking wheel rotatably connected to the support arm, a walking motor driving the walking wheel to rotate, and a battery connected with the walking motor.

by adopting the above technical solution, the column can be supported stably and the walking is relatively stable.

In summary, the present application has the following beneficial effects: 1. It is convenient for the persons to work in the desert; 2. The persons can live in the desert for a long time; 3. It is conducive to the survival of seedlings.

### BRIEF DESCRIPTION OF DRAWINGS

FIG. 1 is the schematic structural diagram of a mobile village;

FIG. 2 is the schematic structural diagram of a base platform;

FIG. 3 is the partial structural diagram of the base platform provided with a house;

FIG. 4 is the front view of the base platform provided with a house;

FIG. 5 is the structural diagram of the ceiling;

FIG. 6 is the structural diagram of a solar rainwater collector;

FIG. 7 is the front view of a solar rainwater collector;

FIG. 8 is the structural diagram of the joint between the lifting channel and the column;

FIG. 9 is the structural diagram of the top end of the column;

FIG. 10 is a partial schematic diagram of the walking mechanism;

FIG. 11 is the structural diagram of a walking mechanism;

FIG. 12 is an enlarged view of part A in FIG. 10;

FIG. 13 is the structural diagram of Embodiment 4;

FIG. 14 is the structural diagram of Embodiment 5;

FIG. 15 is the structural diagram of Embodiment 6.

In the drawings: 1, mobile platform; 11, column; 12, base platform; 121, base unit; 122, culturing area; 13, walking mechanism; 131, walking wheel system; 1311, first support arm; 1312, second support arm; 1313, support wheel; 1314, caterpillar track; 1315, damping spring; 1316, mounting frame; 132, motor push-pull rod; 1321, protective cover; 13211, opening; 1322, runner; 1323, worm; 133, flat car platform; 14, house; 15, ceiling; 151, upper cone part; 152, collection groove; 153, water outlet; 16, lifting device; 161, lifting motor; 162, gear; 163, rack; 164, mounting plate; 17, slide rail; 171, roller; 18, shaft-type wind turbine; 2, sunshade area; 3, anti-wind ground pile; 4, locking mechanism; 41, locking hook; 42, hydraulic cylinder; 43, locking column; 5, functional field; 51, helicopter.

### DETAILED DESCRIPTION

The present application will be further described in detail below in connection with the drawings. Like parts are represented by like reference numbers. It should be noted that the words “front”, “back”, “left”, “right”, “up”, “down”, “bottom” and “top” used in the following description refer to the directions in the drawings, and the words “inside” and “outside” refer to the directions towards or away from the geometric center of a specific component, respectively.

### Embodiment 1

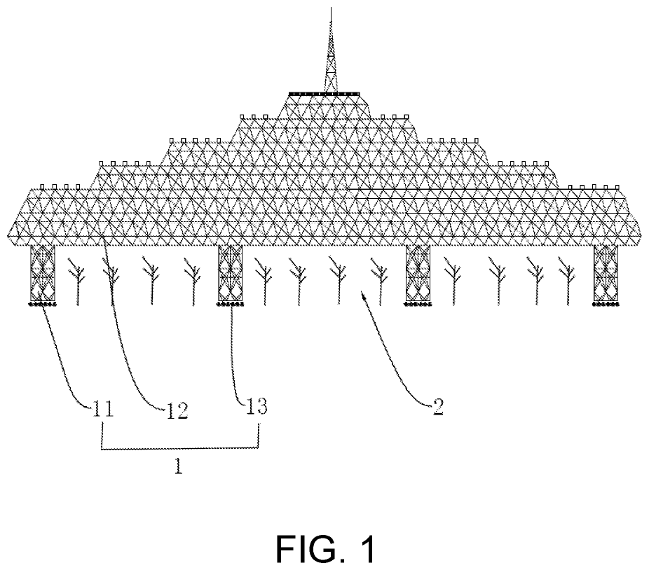

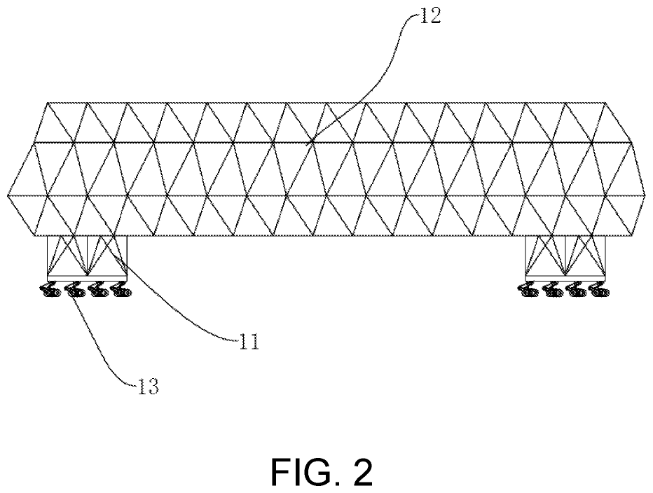

As shown in FIGS. 1 and 2, a production line for afforestation comprises a mobile platform 1, which has a living area formed thereon, a column 11 disposed at the bottom thereof, and a walking mechanism 13 installed at one end of the column 11 opposite to the other end connected with the mobile platform 1 and moving the mobile platform 1 in the desert. The supporting of the column 11 provides some space between the mobile platform 1 and the ground, so that the space under the mobile platform 1 can be used for the operation of an equipment such as a tree planting machine. During the daytime, the sheltering of the mobile platform 1 forms a sunshade zone 2 for cultivating seedlings therein, so as to shelter the newly planted seedlings from the sunlight in the desert, making the newly planted seedlings less likely to die. Furthermore, the people can live in the living area, so that they can work in the desert for a long time.

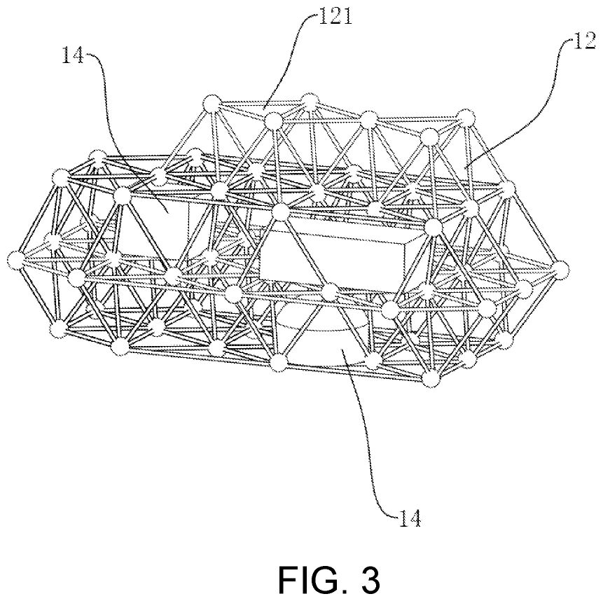

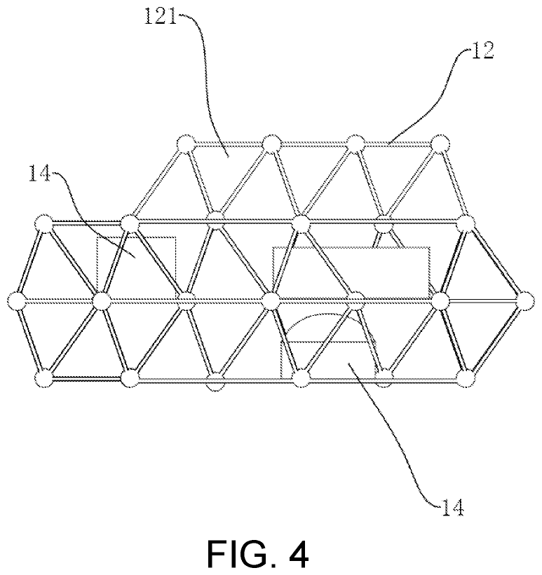

The mobile platform 1 comprises a mobile village, which comprises a base platform 12 and a house 14. Referring to FIGS. 3 and 4, the base platform 12 is of a grid structure, which comprises a plurality of base units 121 having the shape of a pyramid, and in which the plurality of base units 121 are connected and fixed with each other, finally forming the base platform 12. The house 14 is arranged in the gap of the base unit 121, which can be of various shapes, such as cuboid shape, spherical shape, etc. In this way, the base platform 12 having the grid structure is relatively stable and light-weighted compared with the one adopting a whole plate, and the house 14 is also relatively firm when it is installed, preventing it from swaying when it is attacked by a sandstorm. Alternatively, an interconnected corridor (not shown in the FIGS.) can be provided between the houses 14 for a person to walk through.

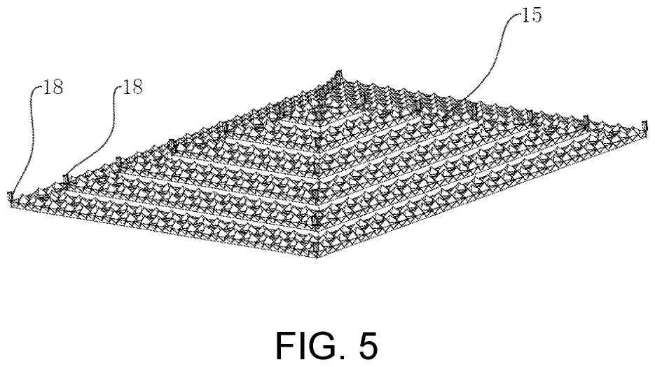

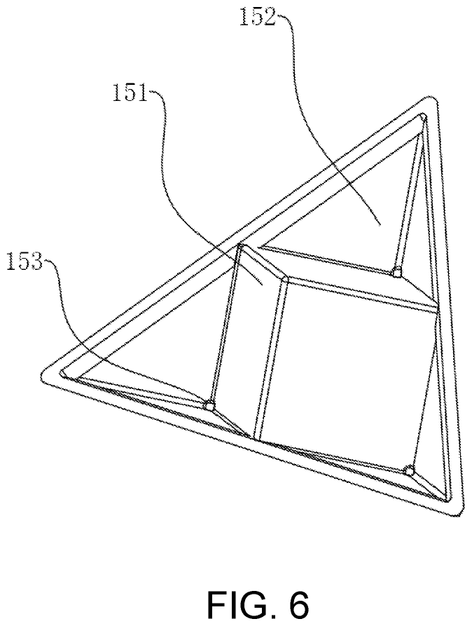

Referring to FIG. 5, the top of the foundation platform 12 is fixedly connected with a ceiling 15, which can be cone-shaped as a whole, with the middle part at a higher position and the edges at a lower position. The ceiling 15 comprises a plurality of solar rainwater collectors (see FIG. 6). In one embodiment, the ceiling 15 is assembled by the plurality of solar rainwater collectors, each of which comprises a plurality of solar panels. In one embodiment, the solar rainwater collector is assembled by the plurality of solar panels in which adjacent solar panels can be fixed and connected by bolts.

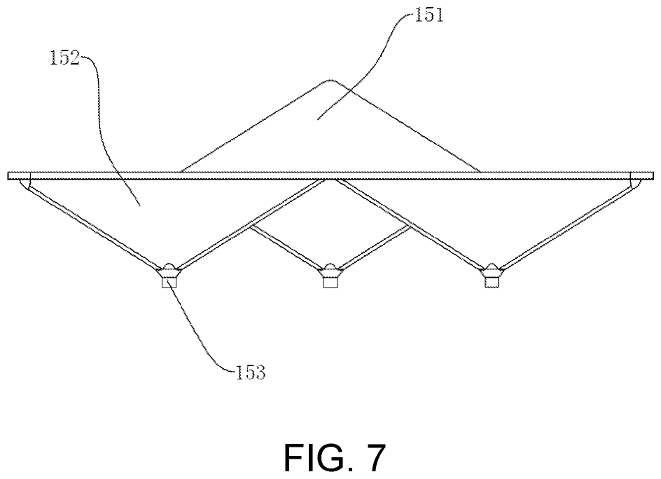

Referring to FIGS. 6 and 7, the solar rainwater collector comprises an upper cone part 151 which protrudes upward and a collection groove 152 which is formed around the upper cone part 151 by downward depression. The edge of the upper cone part 151 and the edge of the collection groove 152 are joined with each other, so that the area of the solar panel receiving the sunlight is relatively large, facilitating receiving the solar energy. Additionally, the bottom of the collection groove 152 is provided with a water outlet 153. Rainwater can be collected by the collection groove 152, flowed out of the water outlet 153, and collected in a container (not shown) for storing water through a pipe, so that it can be used by a person.

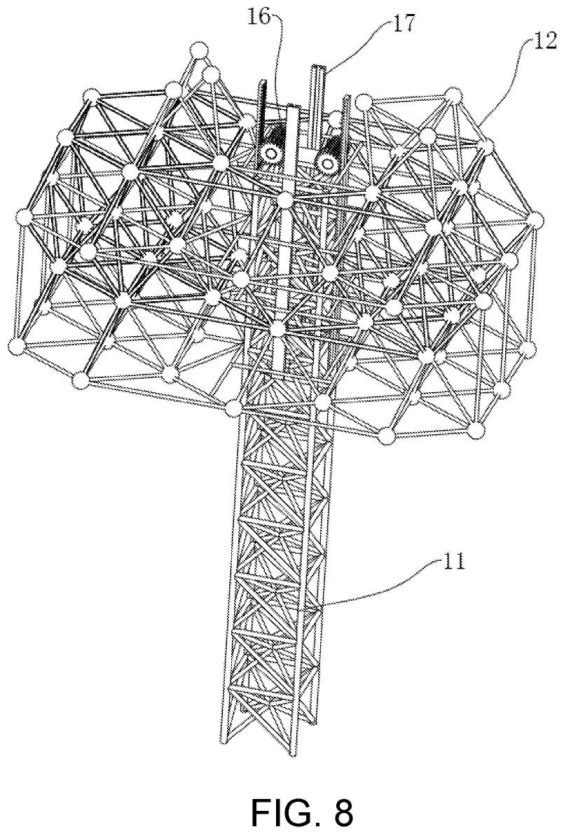

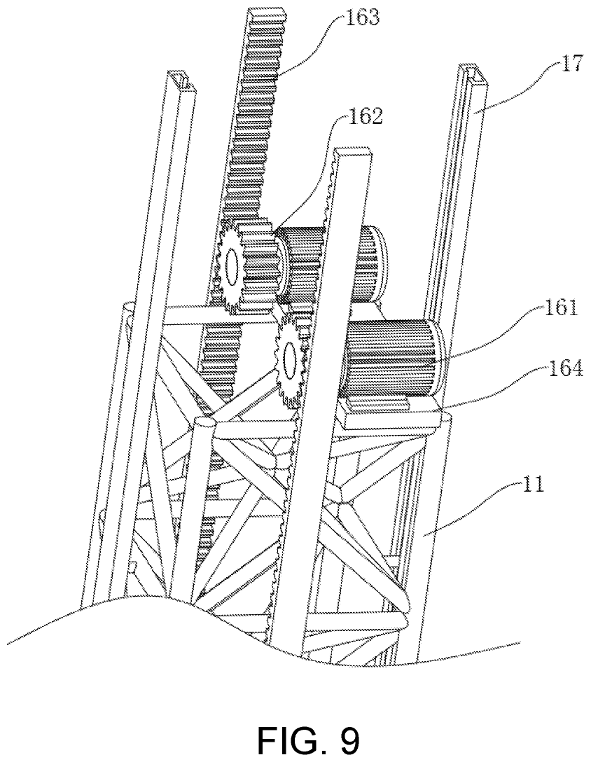

Referring to FIGS. 8 and 9, a lifting channel is formed in the base platform 12 for the column 11 to slide up and down. A lifting device 16 is arranged between the lifting channel and the column 11 to drive one of them relative to the other. The lifting device 16 comprises a lifting motor 161, a gear 162 and a rack 163. The top end of the column 11 is fixedly connected with a mounting plate 164, and the lifting motor 161 is fixedly connected to the mounting plate 164. The output shaft of the lifting motor 161 is connected with the gear 162. The gear 162 can be directly fixed on the output shaft of the lifting motor 161 so as to be directly driven, or a gear 162 box can be provided between the lifting motor 161 and the gear 162 so that they are connected via the gear 162 box. The rack 163 is fixed on the inner side of the lifting channel, and meshes with the gear 162. When machines such as a tree planting machine are working under the mobile platform 1, if some of the machines are high, the lifting motor 161 can be operated to drive the gear 162 to rotate and drive the rack 163, so that the column 11 can be lifted and the space under the base platform 12 becomes expanded, facilitating the operation of the machines. When moving forward, part of the column 11 is withdrawn into the lifting channel to become contracted, so that the base platform 12 has a relatively low height and the center of gravity, facilitating a steady movement.

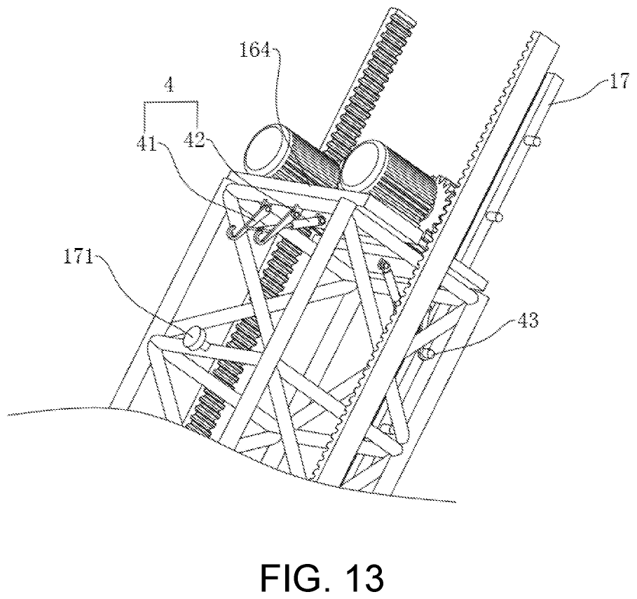

For the purpose of ensuring stable up and down sliding of the column 11, a slide rail 17 is fixed on the inner side of the lifting channel, and a roller 171 being fit with the slide rail 17 in an up and down sliding manner is fixed on the side of the column 11 (referring to FIG. 13).

### Embodiment 2

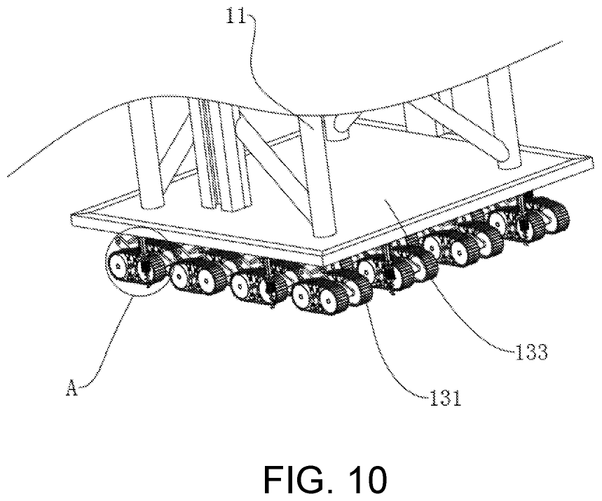

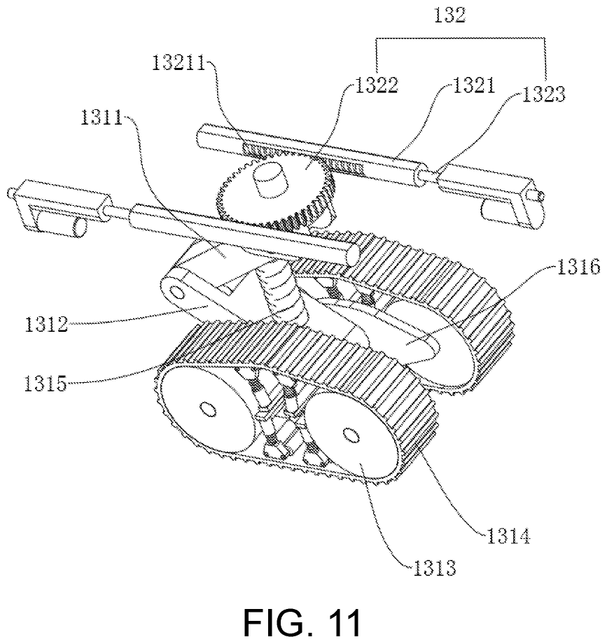

Referring to FIGS. 10 and 11, the walking mechanism 13 comprises a flat car, the flat car comprises a flat car platform 133 and a walking wheel system 131 installed at the bottom of the flat car platform 133. The walking wheel system 131 comprises a plurality of evenly arranged walking wheel sets, each of which can adopt the structure of an aircraft landing gear.

Preferably, for the purpose of better walking in the desert, the adjacent supporting wheels 1313 of the walking wheel sets are equipped with a caterpillar track 1314, so as to prevent the walking wheel sets from being trapped in the sands.

In particular, one embodiment of the walking wheel sets comprises a shock-absorbing support arm, a mounting frame 1316, a support wheel 1313 rotatably connected to the mounting frame 1316, a walking motor driving the support wheel 1313 to rotate, and a battery supplying power for the walking motor. The battery can be powered by solar energy. The shock-absorbing support arm comprises a turntable rotatably connected with the flat car platform 133, a first support arm 1311 hinged with the turntable, and a second support arm 1312 hinged with the first support arm 1311. The end of the second support arm 1312 opposite to the other end hinged with the first support arm 1311 is hinged with the mounting frame 1316, and a damping spring 1315 is arranged between the first support arm 1311 and the second support arm 1312, with the two ends thereof respectively fixedly connected with the first support arm 1311 and the second support arm 1312 to achieve shock-absorbing effect. Each of the walking wheel sets can be equipped with four support wheels 1313, in which two adjacent support wheels 1313 arranged in front and back form one group, and each group of the support wheels 1313 can be equipped with a caterpillar track 1314, so as to advance more smoothly in the desert.

Additionally, for the purpose of convenient steering, the walking wheel sets can further comprise a driving part, which can be a motor, an air cylinder, a hydraulic cylinder 42 or the like, through which the turntable can be driven to rotate, facilitating convenient direction controlling. Of course, a motor push-pull rod 132 can also be used. Referring to FIG. 11, the motor push-pull rod 132 comprises a runner 1322 fixed on the turntable, a worm 1323 meshed with the runner 1322, and a motor driving the worm 1323 to rotate. The motor push-pull rod 132 further comprises a protective cover 1321, and the worm 1323 is rotatably connected in the protective cover 1321. The side of the protective cover 1321 close to the runner 1322 is provided with an opening 13211, through which the worm 1323 and the runner 1322 mesh with each other.

### Embodiment 3

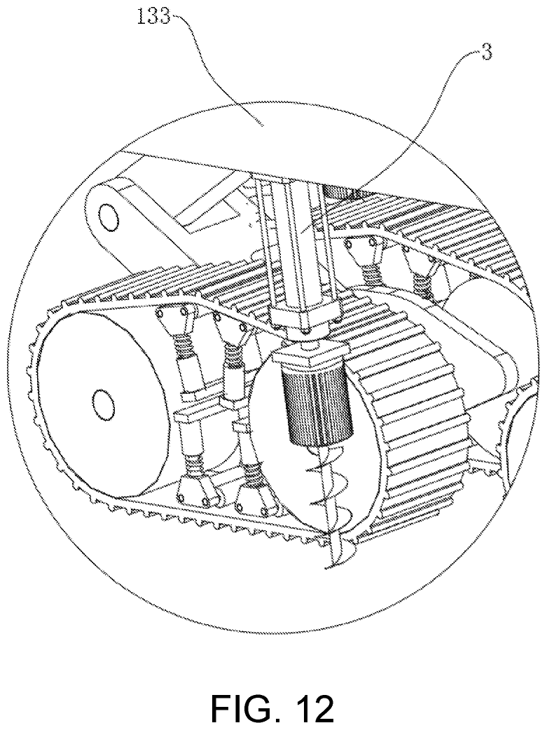

Referring to FIG. 12, an anti-wind ground pile 3 is installed at the bottom of the flat car platform 133, which is driven downward by hydraulic cylinder 42 so as to be driven into the sand, achieving fixing effect against the wind.

### Embodiment 4

Referring to FIG. 13, for the purpose of ensuring the safety and stability of the column 11 after movement, a locking mechanism 4 is arranged between the column 11 and the lifting channel. The locking mechanism 4 comprises a locking column 43, a locking hook 41 and a hydraulic cylinder 42. The locking column 43 can be fixed on both sides of the slide rail 17 or directly on the base platform 12. There are a plurality of the locking columns 43 which are evenly distributed along the height direction. One end of the locking hook 41 is hinged with the top end of the column 11, for example, hinged at the bottom of the mounting plate 164, and the other end forms a hook part matching the locking column 43. One end of the hydraulic cylinder 42 is hinged with the bottom of the mounting plate 164, and the other end is hinged with the locking hook 41. Driven by the hydraulic cylinder 42, the locking hook 41 is rotated around the hinge of the locking hook 41 and the column 11, so that the locking column 43 can be stuck on the hook part. When the column 11 is subject to its own gravity, the locking hook 41 can provide some pulling force, rendering the column 11 stable and uneasy to fall down.

### Embodiment 5

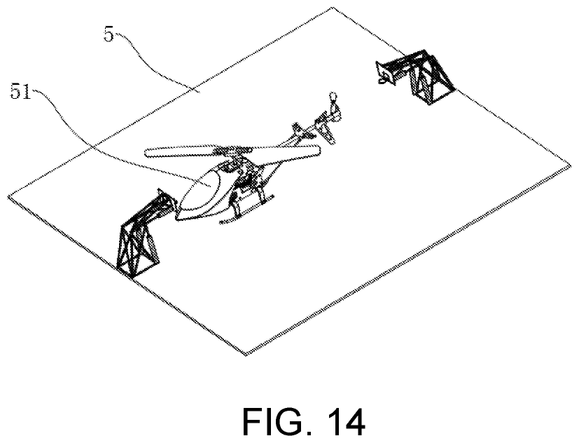

Referring to FIG. 14, the mobile platform 1 comprises a caravan. The caravan also comprises the base platform 12 in which a living layer is provided and rooms are provided in the living layer for a person to rest. The top surface of the base platform 12 is a plane, forming a functional field 5. The functional field 5 can be used as a sports place, or used for taking off and landing of a helicopter 51, through which supplies can be transported to meet the dairy needs of a person or a wounded person can be transported, so as to ensure the safety of the person.

### Embodiment 6

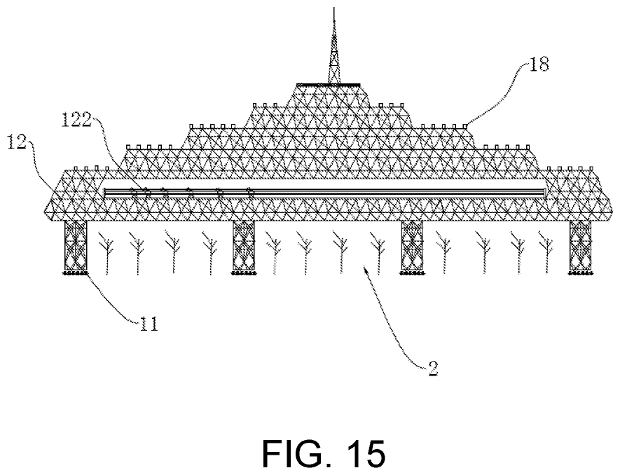

Referring to FIG. 15, the mobile platform 1 further comprises a sunshade, which also comprises the base platform 12 and the ceiling 15. A culture zone 122 is formed in the base platform 12. Small edible animals such as chickens or ducks can be raised in the culture area 122. Railings can be fixed around the base platform 12 to facilitate the captive raising of chickens and ducks. A sunshade zone 2 is further formed below the base platform 12, increasing the applicability thereof.

### Embodiment 7

The house 14 can be made of color plates, so that the house 14 is lighter in weight. Of course, for a better life of the persons, fitness areas and entertainment areas can be further provided on the base platform 12, in which some fitness equipments can be placed in the fitness area and some chess or playing cards can be placed in the entertainment area, so that the persons can live a better life.

### Embodiment 8

Further, for the purpose of providing electric power, a wind power generating equipment can be fixed on the ceiling 15. The wind power generating equipment can be a shaft-type wind turbine 18.

### Embodiment 9

Of course, for the purpose of facilitating operation in the desert, the production line for afforestation can further comprise a seeder, a transplanter, a seedling loader, a well drilling machine, a vehicle mounted generator set and the like, which can be used for facilitating the tree planting operation in the desert.

### Embodiment 10

There are at least three mobile platforms 1, which are arranged in front and back order and advancing at the same speed, with a gap formed between adjacent mobile platforms 1 for sunlight penetration.

The above specific embodiments are merely provided for an explanation to the present application, rather than imposing a limitation thereto. Upon reading the specification, those skilled in the art can make modifications to the embodiment based on needs without paying any creative contribution, which, as long as falling within the scope defined by the claims of the present application, will be protected by the patent law.

What is claimed is:

1. A production line for afforestation, comprising at least one mobile platform, wherein a living area is formed on the mobile platform, a column is disposed at bottom of the mobile platform for forming a sunshade area under the mobile platform for cultivating seedlings, and a walking mechanism is installed at bottom of the column.

2. The production line for afforestation according to claim 1, wherein there are at least three mobile platforms arranged in front and back order and advancing at the same speed, with a gap formed between adjacent mobile platforms for sunlight penetration.

3. The production line for afforestation according to claim 1, wherein the mobile platform comprises a mobile village comprising a base platform having a grid structure in which a house is fixedly connected.

4. The production line for afforestation according to claim 3, wherein a ceiling is installed at the top of the base platform, and the ceiling comprises a plurality of solar panels which are assembled into the ceiling.

5. The production line for afforestation according to claim 4, wherein the ceiling comprises a plurality of solar rainwater collectors, each of the solar rainwater collectors comprises an upper cone part protruding upward and a collection groove formed around the upper cone part by downward depression, an edge of the upper cone part and an edge of the collection groove are joined with each other, and a bottom of the collection groove is provided with a water outlet.

6. The production line for afforestation according to claim 1, wherein the mobile platform comprises a caravan, and the caravan comprises a base platform and a functional field provided on top of the base platform.

7. The production line for afforestation according to claim 4, wherein the mobile platform further comprises a sunshade which comprises the ceiling and the base platform located under the ceiling, with a culturing area formed between the ceiling and the base platform or within the base platform.

8. The production line for afforestation according to claim 1, wherein a lifting channel is formed on the mobile platform, one end of the column is slidably connected to the lifting channel, and a lifting device is arranged between the column and the lifting channel for driving one of the column and the lifting channel to move relative to the other.

9. The production line for afforestation according to claim 8, wherein the lifting device comprises a gear, a lifting motor driving the gear to rotate, and a rack fixed on an inner side of the lifting channel and meshed with the gear.

10. The production line for afforestation according to claim 1, wherein the walking mechanism comprises an electric flat car, the electric flat car comprises a flat car platform, a support arm fixed at a bottom of the flat car platform, a walking wheel rotatably connected to the support arm, a walking motor driving the walking wheel to rotate, and a battery connected with the walking motor.
